(19) United States
(12) Patent Application Publication
(10) Pub. No.: US 2012/0077923 A1
(43) Pub. Date: Mar. 29, 2012

(54) FUNCTIONAL FLUID COMPOSITIONS WITH IMPROVED SEAL SWELL PROPERTIES

(76) Inventor: Cara Siobhan Tredget, Ince Chester Cheshire (GB)

(21) Appl. No.: 13/318,444

(22) PCT Filed: Apr. 29, 2010
(86) PCT No.: PCT/EP2010/055807

§ 371 Date: Dec. 7, 2011

(30) Foreign Application Priority Data
May 1, 2009 (EP) 09251243.3

(51) Int. Cl. C08L 21/00; C10M 105/06; C08K 5/01

(52) U.S. Cl. 524/476; 585/1

(57) ABSTRACT

A functional fluid composition comprising: (a) from 70% to 99.99%, by weight of the fluid composition, of a base oil composition comprising: (i) from 50% to 95%, by weight of the base oil composition, of a naphthenic base oil; and (ii) from 5% to 50%, by weight of the base oil composition, of a Fischer-Tropsch derived base oil. The functional fluid compositions according to the present invention are suitable for use in hydraulic fluids and shock absorber fluids and are useful for reducing the volume swell of synthetic rubbers.

### FIELD OF THE INVENTION

The present invention relates to functional fluid compositions, particularly to functional fluid compositions which are useful as hydraulic fluids and shock absorber fluids and which have improved seal swell properties.

### BACKGROUND OF THE INVENTION

Mineral-based aviation hydraulic fluids commonly use mineral naphthenic base oils in order to meet the low temperature properties required by military specifications for these products, namely MIL-PRF-5606 and MIL-PRF-6083. Both specifications state that approved products must meet a requirement relating to the swelling of synthetic rubbers. In particular, it is a requirement that when the hydraulic fluids are subjected to Test Method FED-STD-791D-3605.5 the elastomer volume swell is between 19-30% for MIL-PRF-5606 and between 19-28% for MIL-PRF-6083. Unfortunately, naphthenic base oils can lead to excessive swelling of synthetic rubbers and in some cases cause a hydraulic fluid to fail specification testing resulting in product waivers or unwanted product. This problem is compounded by global constraints on the supply of naphthenic base oils and a general lack of availability.

It would therefore be desirable to provide a naphthenic-based hydraulic fluid which meets the necessary requirements relating to elastomer volume swell.

### SUMMARY OF THE INVENTION

According to the present invention there is provided a functional fluid composition suitable for use as a hydraulic fluid or shock absorber fluid comprising:

(a) from 70% to 99.99%, by weight of the functional fluid composition, of a base oil composition comprising:
(b) from 50% to 95%, by weight of the base oil composition, of a naphthenic base oil; and
(c) from 5% to 50%, by weight of the base oil composition, of a Fischer-Tropsch derived base oil.

The present invention further relates to shock absorbers and hydraulic systems comprising the functional fluid composition according to the present invention.

It has surprisingly been found that by substituting a portion of the naphthenic base oils used in hydraulic fluids and shock absorber fluids with a Fischer-Tropsch derived base oil, the observed volume swell of synthetic rubbers according to Test Method FED-STD-791D-3605.5 can be significantly reduced.

Hence according to the present invention there is further provided the use of a functional fluid composition as described hereinbelow for reducing the volume swell of synthetic rubbers.

It has also been found that the combination of mineral-derived naphthenic base oil and Fischer-Tropsch derived base oil provides functional fluid compositions having higher specific heat capacities compared to conventional hydraulic fluids containing mineral-derived naphthenic base oils only, which helps to reduce thermal degradation of the functional fluid while in service and extends the useful lifetime of the product.

It has further been found that the functional fluid compositions of the present invention show significantly reduced product loss by evaporation compared to functional fluid compositions containing naphthenic base oils only.

### DETAILED DESCRIPTION OF THE INVENTION

The functional fluid composition of the present invention comprises, as an essential component, a base oil composition.

The base oil composition is present at a level in the range of from 70% to 99.99% by weight, preferably in the range of from 75% to 90% by weight, more preferably in the range of from 80% to 85% by weight.

One essential component of the base oil composition herein is a mineral-derived naphthenic base oil.

As used herein the naphthenic content of the naphthenic base oil is defined as the weight % of total molecules with mono- and multicycloparaffinic functionality. The naphthenic content can be determined by a combination of Liquid Chromatographic Fractionation by HPLC, Field Ionisation Mass Spectroscopy (FIMS) and Proton NMR for olefins, which is described hereinbelow.

Preferably, the naphthenic content of the naphthenic base oil for use herein is in the range of from 50% to 90%, more preferably in the range of from 60% to 80%, by weight of the naphthenic base oil.

The mineral-derived naphthenic base oil is present at a level in the range of from 50% to 95%, preferably in the range of from 70% to 95%, more preferably in the range of from 75% to 85%, by weight of the base oil composition.

There is no particular limitation on the type of mineral-derived naphthenic base oil which can be used in the base oil composition herein. Any mineral-derived naphthenic base oil which is suitable for use in a hydraulic fluid composition or a shock absorber fluid composition can be used in the functional fluid composition herein.

Naphthenic base oils are defined as Group V base oils according to API.

Such mineral-derived base oils are obtained by refinery processes starting from naphthenic crude feeds. Mineral-derived naphthenic base oils for use herein preferably have a pour point of below −20° C. and a viscosity index of below 70. Such base oils are produced from feedstocks rich in naphthenes and low in wax content. Mineral-derived naphthenic base oils are well known and described in more detail in “Lubricant base oil and wax processing”, Avilino Sequeira, Jr., Marcel Dekker, Inc, New York, 1994, ISBN 0-8247-9256-4, pages 28-35.

Methods of manufacture of naphthenic base oils can be found in “Lubricants and Lubrication (Second, Completely Revised and Extended Edition)”, published by Wiley-VCH Verlag GmbH & Co. KgaA, Chapter 4, pages 46-48.

Commercially available sources of naphthenic base oils include those commercially available under the tradename HYDROCAL from Calumet Lubricants Co., those commercially available under the tradename HYPRENE and HYGOLD from Ergon Petroleum Specialties, those naphthenic base oils commercially available from Nynas, and the SNH series of naphthenic base oils commercially available from Sankyo-Yuku.

A particular preferred naphthenic base oil for use herein has a kinematic viscosity at 20° C. in the range of from 4.75 to 5.10, a kinematic viscosity at 40° C. in the range of from 2.90 to 3.20, a minimum flashpoint (ASTM D92) of 101° C., and a minimum pour point of −66° C.

A further essential component of the base oil composition herein is a Fischer-Tropsch derived base oil.

The term “Fischer-Tropsch derived” as used herein means that a material is, or derives from, a synthesis product of a Fischer-Tropsch condensation process. A Fischer-Tropsch derived product may also be referred to as a “GTL (Gas-to-Liquid)” product.

The Fischer-Tropsch derived base oil for use herein preferably has a kinematic viscosity at 100° C. (according to ASTM D445) in the range of from 0.5 to 5 mm²/s.

The Fischer-Tropsch condensation process is a reaction which converts carbon monoxide and hydrogen into longer chain, usually paraffinic, hydrocarbons:

n(CO+2H₂)=(—CH₂—)ₙ+nH₂O+heat,

in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane. In general the gases which are converted into liquid fuel components using Fischer-Tropsch processes can include natural gas (methane), LPG (e.g. propane or butane), “condensates” such as ethane, synthesis gas (CO/hydrogen) and gaseous products derived from coal, biomass and other hydrocarbons.

The Fischer-Tropsch process can be used to prepare a range of hydrocarbon fuels, including LPG, naphtha, kerosene and gas oil fractions. Of these, the gas oils have been used as, and in, automotive diesel fuel compositions, typically in blends with petroleum derived gas oils. The heavier fractions can yield, following hydroprocessing and vacuum distillation, a series of base oils having different distillation properties and viscosities, which are useful as lubricating base oil stocks.

Hydrocarbon products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range and/or hydroisomerisation which can improve cold flow properties by increasing the proportion of branched paraffins. Other post-synthesis treatments, such as polymerisation, alkylation, distillation, cracking-decarboxylation, isomerisation and hydroreforming, may be employed to modify the properties of Fischer-Tropsch condensation products.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP-A-0583836 (pages 3 and 4).

An example of a Fischer-Tropsch based process is the SMDS (Shell Middle Distillate Synthesis) described in “The Shell Middle Distillate Synthesis Process”, van der Burgt et al, paper delivered at the 5^{th} Synfuels Worldwide Symposium, Washington D.C., November 1985; see also the November 1989 publication of the same title from Shell International Petroleum Company Ltd, London, UK. This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as the gas oils useable in diesel fuel compositions. Base oils, including heavy base oils, may also be produced by such a process. A version of the SMDS process, utilising a fixed bed reactor for the catalytic conversion step, is currently in use in Bintulu, Malaysia and its gas oil products have been blended with petroleum derived gas oils in commercially available automotive fuels.

By virtue of the Fischer-Tropsch process, a Fischer-Tropsch derived base oil has essentially no, or undetectable levels of, sulphur and nitrogen. Compounds containing these heteroatoms tend to act as poisons for Fischer-Tropsch catalysts and are therefore removed from the synthesis gas feed. This can bring additional benefits to functional fluid compositions in accordance with the present invention.

Further, the Fischer-Tropsch process as usually operated produces no or virtually no aromatic components. The aromatics content of a Fischer-Tropsch derived base oil component, suitably determined by ASTM D-4629, will typically be below 1 wt %, preferably below 0.5 wt % and more preferably below 0.1 wt % on a molecular (as opposed to atomic) basis.

Generally speaking, Fischer-Tropsch derived hydrocarbon products have relatively low levels of polar components, in particular polar surfactants, for instance compared to petroleum derived hydrocarbons. This may contribute to improved antifoaming and dehazing performance. Such polar components may include for example oxygenates, and sulphur and nitrogen containing compounds. A low level of sulphur in a Fischer-Tropsch derived hydrocarbon is generally indicative of low levels of both oxygenates and nitrogen containing compounds, since all are removed by the same treatment processes.

The Fischer-Tropsch derived base oil is present in the functional fluid composition herein at a level of at least 5%, preferably at least 10%, more preferably at least 15%, by weight of the functional fluid composition.

The Fischer-Tropsch derived base oil is preferably present in the functional fluid composition herein at a level of at most 50%, more preferably at most 40% and even more preferably at most 30%, by weight of the functional fluid composition.

Suitable Fischer-Tropsch derived base oils that may be conveniently used as base oil in the functional fluid composition of the present invention are those as for example disclosed in EP 0 776 959, EP 0 668 342, WO 97/21788, WO 00/15736, WO 00/14188, WO 00/14187, WO 00/14183, WO 00/14179, WO 00/08115, WO 99/41332, EP 1 029 029, WO 01/18156, WO 01/57166 and WO04/07647.

In one preferred embodiment of the present invention the Fischer-Tropsch derived base oil has a kinematic viscosity at 100° C. in the range of from 0.5 to 2 mm²/s, preferably from 1 to 1.5 mm²/s (referred to herein as a GTL Gas Oil or “GTL GO”).

In another preferred embodiment of the present invention, the Fischer-Tropsch derived base oil has a kinematic viscosity at 100° C. in the range of from 2 to 4 mm²/s, preferably in the range of from 2 to 3 mm²/s.

A particularly preferred Fischer-Tropsch base oil for use herein is GTL 3.

The kinematic viscosity at 40° C. of the base oil composition preferably is in the range of from 1 to 30 mm²/s, more preferably in the range of from 1 to 15 mm²/s, even more preferably between 2 to 10 mm²/s, yet more preferably between 3 to 4 mm²/s.

The base oil composition may suitably have a kinematic viscosity at 100° C. of below 20 mm²/s, more preferably below 15 mm²/s, again more preferably in the range of from 1 to 10 mm²/s, and yet more preferably in the range of from 1 to 5 mm²/s, and most preferably below 1.5 mm²/sec. The pour point of the base oil composition is preferably at or below −30° C.

The functional fluid composition of the present invention preferably has a kinetic viscosity at 100° C. of at least 3 mm²/s, preferably at least 4 mm²/s, even more preferably at least 4.9 mm²/s. The functional fluid composition of the present invention preferably has a kinetic viscosity at 100° C. of at most 10 mm²/s, preferably at most 7 mm²/s, even more preferably 6 mm²/s.

The functional fluid of the present invention preferably has a pour point of below or at −30° C., preferably below or at −50° C.

The functional fluid composition according to the invention preferably has a viscosity index in the range of from 100 to 600. The functional fluid composition according to the invention further preferably has a kinematic viscosity at 40° C. of at least 7 mm²/s.

The flash point of the base oil composition as measured by ASTM D92 may be even greater than 120° C., or even greater than 140° C. The flash point of the base oil composition will depend on the application of the oil. Preferably, the functional fluid composition has a flashpoint of at or greater than 80° C.

The functional fluid composition according to the invention may comprise one or more additional base oils, in addition to the mineral-derived naphthenic base oil and the Fischer-Tropsch derived base oil. The additional base oil will suitably comprise less than 20% by weight, more preferably less than 10% by weight, again more preferably less than 5% by weight of the total functional fluid formulation. Examples of such base oils are mineral based paraffinic type base oils and synthetic base oils, for example poly alpha olefins, poly alkylene glycols and the like.

The functional fluid composition further preferably comprises at least one other additional lubricant component in effective amounts, such as for instance polar and/or non-polar lubricant base oils, and performance additives such as for example, but not limited to, metallic and ashless oxidation inhibitors, metallic and ashless dispersants, metallic and ashless detergents, corrosion and rust inhibitors, metal deactivators, metallic and non-metallic, low-ash, phosphorus-containing and non-phosphorus, sulphur-containing and non-sulphur-containing anti-wear agents, metallic and non-metallic, phosphorus-containing and non-phosphorus, sulphur-containing and non-sulphurous extreme pressure additives, anti-seizure agents, pour point depressants, wax modifiers, viscosity modifiers, seal compatibility agents, friction modifiers, lubricity agents, anti-staining agents, chromophoric agents, anti foaming agents, demulsifiers, and other usually employed additive packages. For a review of many commonly used additives, reference is made to D. Klamann in Lubricants and Related Products, Verlag Chemie, Deerfield Beach, Fla.; ISBN 0-89573-177-0, and to “Lubricant Additives” by M. W. Ranney, published by Noyes Data Corporation of Parkridge, N.J. (1973).

The functional fluid composition according to the invention preferably comprises a viscosity improver (b) in an amount of from 0.01 to 30% by weight.

Viscosity index improvers (also known as VI improvers, viscosity modifiers, or viscosity improvers) provide lubricants with high- and low-temperature operability. These additives impart shear stability at elevated temperatures and acceptable viscosity at low temperatures. Suitable viscosity index improvers include both low molecular weight and high molecular weight hydrocarbons, polyesters and viscosity index improver dispersants that function as both a viscosity index improver and a dispersant. Typical molecular weights of these polymers are between about 10,000 to 1,000,000, more typically about 20,000 to 500,00, and even more typically between about 50,000 and 200,000. Examples of suitable viscosity index improvers are polymers and copolymers of methacrylate, butadiene, olefins, or alkylated styrenes. The viscosity index improvers may be used in an amount of 0.01 to 30% by weight, preferably 0.01 to 25% by weight, yet more preferably from 0.01 to 20% by weight, again more preferably from 0.1 to 18% by weight, and most preferably from 5 to 15% by weight, based on the total functional fluid composition.

Polyisobutylene is a commonly used viscosity index improver. Other suitable viscosity index improvers include copolymers of ethylene and propylene, hydrogenated block copolymers of styrene and isoprene, and polyacrylates, such as styrene-isoprene or styrene-butadiene based polymers of about 50,000 to 200,000 molecular weight. Preferably, the viscosity index improver comprises poly methyl methacrylate (further referred to as PMMA), i.e. a copolymer of various chain length methyl and alkyl methacrylates. Accordingly, the functional fluid composition according to the invention comprises a viscosity improver comprising a polymethylmethacrylate polymer. Particularly preferred PMMA viscosity index improvers are those commercially available Viscoplex viscosity improvers (Viscoplex is a tradename of the Röhm GmbH & CO. KG, Darmstadt, Germany), in particular Viscoplex 7-310, Viscoplex 7-300 and Viscoplex 7-305.

Preferable additional antiwear additives to be used with the composition according to the invention include metal alkylthiophosphates, more particularly zinc dialkyldithiophosphates, typically used in amounts of from about 0.4% by weight to about 1.4% by weight of the total functional fluid composition.

Other preferred antiwear additives include triaryl phosphates, such as those available from Chemtura under the tradenames Reolube OMTI, Durad 310M, Durad 110, Durad 150B, Reolube TXP, Durad 220B, Durad 620B, Durad 110B, Fryquel 150 and Fryquel 220, those available from Rhein Chemie under the tradenames Additin RC 3661, Additin RC 3760 and Additin RC 3680 and those commercially available from Supresta under the tradenames SynOAd 8475, SynOAd 8484, SynOAd 8485, SynOAd 8478, SynOAd 8477, SynOAd 8499 and SynOAd 9578. Included within the term triaryl phosphates are tricresyl phosphates, such as those approved to the specification TT-T-656.

Other preferred antiwear additives include phosphorus-free antiwear additives such as sulphur-containing aliphatic, arylaliphatic or alicyclic olefinic hydrocarbons containing from about 3 to 30 carbon atoms, more preferably 3 to 20 carbon atoms. Again more preferred hydrocarbon radicals are alkyl or alkenyl radicals, as for instance disclosed in U.S. Pat. No. 4,941,964.

Other preferred antiwear additives include polysulfides of thiophosphorus acids and thiophosphorus acid esters, and phosphorothionyl disulfides as disclosed in U.S. Pat. No. 2,443,264; U.S. Pat. No. 2,471,115; U.S. Pat. No. 2,526,497; U.S. Pat. No. 2,591,577; and U.S. Pat. No. 3,770,854. Use of alkyl-thiocarbamoyl compounds, such as bis(dibutyl)thio-carbamoyl in combination with a molybdenum compounds such as oxymolybdenum diisopropylphosphorodithioate sulfide and a phosphorus ester such as dibutyl hydrogen phosphite as antiwear additive disclosed in U.S. Pat. No. 4,501,678. U.S. Pat. No. 4,758,362 discloses use of a carbamate additive to provide improved antiwear and extreme pressure properties. The use of thiocarbamate as an antiwear additive is disclosed in U.S. Pat. No. 5,693,598. Esters of glycerol may be used as antiwear agents. For example, mono-, di, and tri-oleates, mono-palmitates and mono-myristates may preferably be used. U.S. Pat. No. 5,034,141 discloses a combination of a zinc dialkyldithiophosphate, a thiodixanthogen compound and a metal thiophosphate that result in improved antiwear properties. U.S. Pat. No. 5,034,142 discloses that use of a metal alkyoxyalkylxanthate and a dixanthogen in combination with zinc dialkyldithio-phosphate may improve antiwear properties. Generally, antiwear additives may be used in an amount of about 0.01 to 6% by weight, preferably about 0.01 to 4% by weight, based on the total weight of the fluid composition.

Suitable antioxidants retard the oxidative degradation of the functional fluid composition during service. Such degradation may result in deposits on metal surfaces, the presence of sludge, or a viscosity increase in the fluid. A wide variety of suitable oxidation inhibitors are known, as for instance those described in Klamann in Lubricants, and for example U.S. Pat. No. 4,798,684 and U.S. Pat. No. 5,084,197. Useful antioxidants include hindered phenols. These phenolic antioxidants may be ashless (metal-free) phenolic compounds or neutral or basic metal salts of certain phenolic compounds. Typical phenolic antioxidant compounds are the hindered phenolics which are the ones which contain a sterically hindered hydroxyl group, and these include those derivatives of dihydroxy aryl compounds in which the hydroxyl groups are in the o- or p-position to each other. Examples of phenolic materials of this type include 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include for example hindered 2,6-di-alkyl-phenolic proprionic ester derivatives.

Bis-phenolic antioxidants may also be advantageously used in the functional fluid composition. Non-phenolic oxidation inhibitors which may be used include aromatic amine antioxidants and these may be used either as such or in combination with phenolics. Typical examples of non-phenolic antioxidants include alkylated and non-alkylated aromatic amines such as aromatic monoamines with aliphatic, aromatic or substituted aromatic group substituents at the nitrogen atom. Typical aromatic amines antioxidants have alkyl substituent groups of at least about 6 carbon atoms. Examples of aliphatic groups include hexyl, heptyl, octyl, nonyl, and decyl. Generally, the aliphatic groups will not contain more than about 14 carbon atoms. The general types of amine antioxidants useful in the present compositions include diphenylamines, phenyl naphthylamines, phenothiazines, imidodibenzyls and diphenyl phenylene diamines. Mixtures of two or more aromatic amines are also useful. Polymeric amine antioxidants may also be used. Particular examples of aromatic amine antioxidants useful in the present invention include: p,p′-dioctyldiphenylamine; t-octyl-phenyl-alpha-naphthylamine; phenyl-lphanaphthylamine; and p-octylphenyl-alpha-naphthylamine. Sulphurized alkyl phenols and alkali or alkaline earth metal salts thereof also are useful antioxidants. Low sulfur peroxide decomposers are useful as antioxidants. Another class of suitable antioxidants are oil soluble copper compounds. Examples of suitable copper antioxidants include copper dihydrocarbyl-thio or dithio-phosphates and copper salts of carboxylic acids. Other suitable copper salts include copper dithiacarbamates, sulphonates, phenates, and acetylacetonates. Basic, neutral, or acidic copper Cu(I) and or Cu(II) salts derived from alkenyl succinic acids or anhydrides are known to be particularly useful. Preferred antioxidants include hindered phenols, arylamines, low sulfur peroxide decomposers and other related components. These antioxidants may be used individually by type or in combination with one another. Such additives may be used in an amount of about 0.01 to 5% by weight, preferably about 0.01 to 2% by weight.

Detergents useful as additives may be simple detergents or hybrid or complex detergents. The latter can provide the properties of two detergents without the need to blend separate materials, as for instance described in U.S. Pat. No. 6,034,039. Suitable detergents include anionic compounds that contain a long chain oleophillic portion of the molecule and a smaller anionic or oleophobic portion of the molecule. The anionic portion of the detergent is typically derived from an organic acid such as a sulphuric acid, carboxylic acid, phosphorus acid, phenol, or mixtures thereof. The counter ion is typically an alkaline earth or alkali metal. Salts that contain a substantially stoichiometric amount of the metal are described as neutral salts and have a total base number (TBN, as measured by ASTM D2896) of from 0 to 80. Preferred detergents include the alkali or alkaline earth metal salts of sulfates, sulfonates, phenates, carboxylates, phosphates, and salicylates. Suitable alkaryl sulfonates typically contain about 9 to about 80 or more carbon atoms, more typically from about 16 to 60 carbon atoms. Preferred are those disclosed in Klamann in Lubricants and Related Products, and in “Lubricant Additives” cited above, and C. V. Smallheer and R. K. Smith, published by the Lezius-Hiles Co. of Cleveland, Ohio (1967). Alkaline earth phenolates represent another useful class of detergents. These detergents are the products of reacting alkaline earth metal hydroxides or oxides with an alkyl phenol or sulphurized alkylphenol. Useful alkyl groups include straight chain or branched C₁-C₃₀ alkyl groups, preferably, C₄-C₂₀. Examples of suitable phenols include isobutylphenol, 2-ethylhexyl-phenol, nonylphenol, 1-ethyldecylphenol, and the like. Metal salts of carboxylic acids are also useful as detergents. Another preferred class of detergents are alkaline earth metal salicylates, including monoalkyl to tetraalkyl salicylates, wherein the alkyl groups have from 1 to 30 carbon atoms. Preferably, the alkaline earth metal is calcium, magnesium, or barium; calcium being the most preferred. Another useful class of detergents encompasses alkaline earth metal phosphates. Typically, the total detergent concentration is about 0.01 to about 6% by weight, preferably, about 0.1 to 4% by weight, calculated on the total functional fluid composition. In addition, non-ionic detergents may be preferably used in lubricating compositions. Such non-ionic detergents may be ashless or low-ash compounds, and may include discrete molecular compounds, as well as oligomeric and/or polymeric compounds.

The additives may further comprise dispersants. Suitable dispersants typically contain a polar group attached to a relatively high molecular weight hydrocarbon chain. The polar group typically contains at least one element of nitrogen, oxygen, or phosphorous. Typical hydrocarbon chains contain about 50 to 400 carbon atoms. Suitable dispersants include phenolates, sulfonates, sulphurized phenolates, salicylates, naphthenates, stearates, carbamates and thiocarbamates. A particularly useful class of dispersants are alkenylsuccinic derivatives, in which the alkenyl chain constitutes the oleophilic portion of the molecule which confers solubility in the oil. The alkenyl chain may be a polyisobutylene group, such as those described in U.S. Pat. No. 3,172,892; U.S. Pat. No. 3,2145,707; U.S. Pat. No. 3,219,666; U.S. Pat. No. 3,316,177; U.S. Pat. No. 3,341,542; U.S. Pat. No. 3,454,607; U.S. Pat. No. 3,541,012; U.S. Pat. No. 3,630,904; U.S. Pat. No. 3,632,511; U.S. Pat. No. 3,787,374 and U.S. Pat. No. 4,234,435.

Other types of suitable dispersants are described in U.S. Pat. No. 3,036,003; U.S. Pat. No. 3,200,107; U.S. Pat. No. 3,254,025; U.S. Pat. No. 3,275,554; U.S. Pat. No. 3,438,757; U.S. Pat. No. 3,454,555; U.S. Pat. No. 3,565,804; U.S. Pat. No. 3,413,347; U.S. Pat. No. 3,697,574; U.S. Pat. No. 3,725,277; U.S. Pat. No. 3,725,480; U.S. Pat. No. 3,726,882; U.S. Pat. No. 4,454,059; U.S. Pat. No. 3,329,658; U.S. Pat. No. 3,449,250; U.S. Pat. No. 3,519,565; U.S. Pat. No. 3,666,730; U.S. Pat. No. 3,687,849; U.S. Pat. No. 3,702,300; U.S. Pat. No. 4,100,082; U.S. Pat. No. 5,705,458; and EP-A-471071.

Other suitable dispersants include hydrocarbyl-substituted succinic acid compounds, such as succinimides, succinate esters, or succinate ester amides prepared by the reaction of hydrocarbon-substituted succinic acid preferably having at least 50 carbon atoms in the hydrocarbon substituent, with at least one equivalent of an alkylene amine, are particularly useful.

More preferred succinic dispersants include borated and non-borated succinimides, including those derivatives from mono-succinimides, bis-succinimides, and/or mixtures of mono- and bis-succinimides, wherein the hydrocarbyl succinimide is derived from an alkylene group such as polyisobutylene having a Mn of from about 500 to about 5000. Other preferred dispersants include succinic acid-esters and amides, alkylphenolpolyamine Mannich adducts, their capped derivatives, and other related components. Such additives may be used in an amount of about 0.1 to 20% by weight preferably about 0.1 to 8% by weight.

Other useful dispersants include oxygen-containing compounds, such as polyether compounds, polycarbonate compounds, and/or polycarbonyl compounds, as oligomers or polymers, ranging from low molecular weight to high molecular weight.

Friction modifiers i.e. a material or compound that can alter the coefficient of friction of the fluid may be effectively used in combination with the base oil components. Suitable friction modifiers may include metal salts or metal-ligand complexes where the metals may include alkali, alkaline earth, or transition group metals, as those described in WO2004/053030.

Other useful additives include pour point depressants to lower the minimum temperature at which the fluid will flow or can be poured. Examples of suitable pour point depressants include polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers, such as those referred to in WO2004/053030.

Suitable seal compatibility agents include organic phosphates, aromatic esters, aromatic hydrocarbons, esters (butylbenzyl phthalate, for example), and polybutenyl succinic anhydride.

Such additives may be used in an amount of about 0.01 to 3% by weight.

Anti-foaming agents may advantageously be added to the functional fluid compositions. These agents retard the formation of stable foams. Silicones and organic polymers are typical anti-foam agents, such as for example polysiloxanes. Anti-foam agents are commercially available and may be used in conventional minor amounts along with other additives such as demulsifiers; usually the amount of these additives combined is less than 1% by weight.

Suitable corrosion inhibitors are those referred to in Klamann, as cited above. Examples of suitable corrosion inhibitors include thiadiazoles, tolutriazoles, zinc dithiophosphates, metal phenolates, basic metal sulfonates, fatty acids and amines. Such additives may be used in an amount of from about 0.01 to 5% by weight, preferably from about 0.01 to 1.5% by weight, more preferably from about 0.01 to 1% by weight. Examples of suitable corrosion inhibitors can be found in, for example, U.S. Pat. No. 2,719,125; U.S. Pat. No. 2,719,126; and U.S. Pat. No. 3,087,932. Examples of suitable corrosion inhibitors are those commercially available under the tradenames Irgamet 39, Irgamet TTA and Irgamet 42 from Ciba and that commercially available under the tradename Vanlube 887 from Vanderbilt.

Additional types of additives may be further incorporated into the functional fluid compositions of this invention may include one or more additives such as, for example, demulsifiers, solubilizers, fluidity agents, colouring agents, chromophoric agents, and the like. Each additive may include individual additives or mixtures thereof.

The present invention further relates to shock absorbers and hydraulic systems comprising the functional fluid according to the invention, as well as to a vehicle comprising a shock absorber and/or hydraulic system. Shock absorbers are expected to have high response values already at low temperatures, while both applications show the high biodegradability and the superior low temperature performance.

A shock absorber (sometimes referred to as a damper) is a mechanical device designed to smooth out or damp a sudden shock impulse and dissipate kinetic energy. Shock absorbers are an important part of automobile or bicycle suspensions, aircraft landing gear, and the supports for many industrial machines. Large shock absorbers are also used in architecture and civil engineering to reduce the susceptibility of structures to earthquake damage and resonance. Applied to a structure such as a building or bridge it may be part of a seismic retrofit or as part of new, earthquake resistant construction. In this application it allows yet restrains motion and absorbs resonant energy, which could otherwise cause excessive motion and eventual structural failure.

Shock absorbers generally have the task of converting kinetic energy to heat energy, which can then be dissipated. Hydraulic shock absorbers usually are composed of a cylinder with a sliding piston inside. The cylinder is filled with a fluid. This fluid filled piston/cylinder combination is also referred to as a dashpot. In a transport vehicle such as a bicycle fork, as described for instance in JP-A-2004-44643, or bicycle rear wheel suspension, passenger car or heavy duty transport vehicles or aircraft landing gear, the wheel suspension usually contains several shock absorbers, mostly in combination with a pressure resilient means such as coil springs, leaf springs, or torsion bars. These springs are not shock absorbers as springs only store and do not dissipate or absorb energy. If a wheel is put into a horizontal motion, the spring will absorb the up- and downward force, and convert this into heat. The shock absorber, along with hysteresis in for instance the tires of the wheel, dampens the motion of the unsprung weight up and down, thereby effectively damping the wheel bounce.

This is achieved by converting the kinetic energy into heat through fluid friction due to the flow of the shock absorber fluid through a narrow orifice, such as an internal valve. The functional fluids according to the invention are particularly useful as shock absorbing fluids due to the fact that the specific heat capacity of products containing Fischer-Tropsch derived base oils are higher than those containing only naphthenic base oils. Upon absorbing the same amount of energy on landing a fluid with a higher specific heat capacity affects a smaller rise in fluid temperature than a fluid with a lower specific heat capacity. This helps reduce thermal degradation of the fluid while in service and extends the useful lifetime of the product.

The functional fluid compositions of the present invention preferably have a specific heat capacity according to ASTM E1269 (at 70° C.) in the range of from 1.0 to 3.0, preferably in the range of from 1.5 to 2.5, most preferably in the range of from 1.9 to 2.2 Joules/g/° C.

In hydraulic systems, the fluid has the role of transferring kinetic energy from one location to another within a closed system, for instance in the control of airplane steering and landing gears. It has been found that the functional fluid compositions according to the invention are particularly useful as aviation hydraulic fluids due to their desirable low temperature properties together with the fact that the functional fluid compositions of the present invention significantly reduce the observed volume swell of synthetic rubbers.

The present invention will now be described by reference to the following Examples:

### EXAMPLES

### Comparative Example 1

The fluid composition of Comparative Example 1 was prepared by blending a naphthenic base oil having the properties as shown in Table 1 below with a standard additive package. The additive package was present at a level of approximately 16.5% by weight of the fluid composition. The additive package contained a polyalkyl methacrylate viscosity improver diluted in mineral oil, a triaryl phosphate, a BHT antioxidant, and a tolutriazole corrosion inhibitor.

TABLE 1
Properties of Naphthenic Base Oil

| | | | Naphthenic |
|---|---|---|---|
| Property | Test Method | Units | base oil |
| Vk @ 20° C. | D445 | mm²/s | 4.75-5.10 |
| Vk @ 40° C. | D445 | mm²/s | 2.90-3.20 |
| Minimum | ASTM D92 | ° C. | 101 |
| flashpoint | | | |
| Minimum Pour | D5950 | ° C. | −66 |
| point | | | |

The naphthenic content of the naphthenic base oil used in Comparative Example 1 was determined by a combination of Liquid Chromatographic Fractionation by HPLC, Field Ionisation Mass Spectroscopy (FIMS) and Proton NMR for olefins. Liquid Chromatographic Fractionation by HPLC was carried out according to a modified method based on IP368/95. The modification involved using pentane rather than hexane as a solute. In this method the saturate and aromatic fraction of the base oil are separated according to polarity. The relative proportion of saturates and aromatics together with the overall percentage recovery are shown in Table 2 below.

TABLE 2

| | Saturates | Aromatics | Recovery |
|---|---|---|---|
| Sample Name | % m/m | % m/m | % m/m |
| Naphthenic | 91.1 | 9.1 | 100.2 |
| Base Oil used | | | |
| in | | | |
| Comparative | | | |
| Example 1 | | | |

FIMS was used to semi-quantitatively determine the concentration of hydrocarbon types in terms of their carbon number and hydrogen deficiency. The type classification of compounds in mass spectroscopy is determined by the characteristic ions formed and is normally classified by “z-number”. This is given by the general formula for all hydrocarbon species; CnH(2n+z), where n is the number of carbon atoms and z is the degree of hydrogen deficiency. The stoichiometry and the hydrocarbon is fully described if n and z are known. For components such as base oils there is a degree of overlap in some of the hydrocarbon types, e.g. for an alkyl benzene z=−6, and this is also the case for a four ring cycloparaffin (z=−6). Therefore in order to provide distinction between such hydrocarbon types it is necessary to separate the samples into saturate and aromatic fractions prior to mass spectroscopic analysis. Table 3 below shows the relative % for the naphthenic base oil used in Comparative Example 1 according to the z number of the series.

TABLE 3

| Z number: | 2 | 0 | −2 | −4 | −6 | Other | Total |
|---|---|---|---|---|---|---|---|
| Relative % | 13.65 | 39.04 | 34.90 | 10.76 | 1.54 | 0.11 | 100 |

The FIMS results show that the naphthenic base oil used in Comparative Example 1 contains significant amounts of Z=0, −2 and −4 material, assumed to be mono-, di-, and tri-naphthenes. However, FIMS can only comment on the species Z number and not the exact structural type. This leads to the possibility that olefins are present as they can have the same mass and formula as naphthenes. In order to confirm that the molecules present in the naphthenic base oil of Comparative Example 1 are indeed naphthenic rather than olefinic ¹H NMR was carried out on the saturate fraction in order to determine the % weight olefins. This was determined as <100 ppm. Therefore the overall naphthenic content of the saturates fraction can be considered to be around 85%. As the saturates fraction makes up approximately 91% of the total base oil the overall naphthenic content of the base oil can be considered to be approximately 76.5%.

In addition to the naphthenic content the % weight of individual carbon atoms within a saturated cyclic environment was determined for the naphthenic base oil of Comparative Example 1 using the Brandes IR method. This determines the weight % of carbon atoms in each of the following environments: linear paraffinic environment (C_{P}); cycloparaffinic environment (C_{N}) and olefinic environment (C_{A}). The results are shown in Table 4 below.

TABLE 4

| Carbon | | | |
|---|---|---|---|
| Environment | % C_{P} | % C_{N} | % C_{A} |
| Naphthenic | 42.6 | 51.8 | 5.6 |
| base oil of | | | |
| Comparative | | | |
| Example 1 | | | |

### Examples 1-3

Examples 1-3 were prepared by blending a naphthenic base oil with a Fischer-Tropsch derived base oil in the amounts as set out in Table 6 below. The naphthenic base oil used in Example 1-3 is the same as that used in Comparative Example 1.

The Fischer-Tropsch derived base oil used in Examples 1 and 2 was “GTL 3” having a viscosity at 100° C. of 2.68 mm²/s. The Fischer-Tropsch derived base oil used in Example 3 was “GTL-GO”, a Fischer-Tropsch derived gas oil having a viscosity at 100° C. of 1.255 mm²/s. GTL 3 and GTL-GO can be prepared by the method described in WO2004/07647. The properties of GTL 3 and GTL GO are shown in Table 5 below.

TABLE 5

| | Test | | | |
|---|---|---|---|---|
| Property | Method | Units | GTL 3 | GTL GO |
| Vk @ 100° C. | D445 | mm²/s | 2.68 | 1.255 |
| Vk @ 40° C. | D445 | mm²/s | 9.581 | 3.128 |
| Density @ | D2983 | CP | — | 50/40 |
| −40° C. | | | | |
| VI | D2270 | | 119 | — |
| Pour Point | D5950 | ° C. | −42 | −51 |

The additive package used in Comparative Example 1 was blended into each of the Examples 1-3 in identical amounts as used in Comparative Example 1.

TABLE 6

| | % naphthenic | | % GTL Gas |
|---|---|---|---|
| Example | base oil | % GTL 3 | Oil |
| Comparative | 100 | 0 | 0 |
| Example 1 | | | |
| Example 1 | 80 | 20 | 0 |
| Example 2 | 90 | 10 | 0 |
| Example 3 | 80 | 0 | 20 |

Various physical properties of the fluids of Examples 1-3 and Comparative Example 1 were measured as set out in Tables 7 and 8 below.

TABLE 7

| | | Viscosity | Viscosity |
|---|---|---|---|
| | Pour Point | (40° C.) | (100° C.) |
| | (Test | (Test | (Test |
| | Method | Method | Method |
| Example | D5950) | D445) | D445) |
| Comparative | −69° C. | 14.7 | 5.5 |
| Example 1 | | | |
| Example 1 | −66° C. | 14.8 | 5.4 |
| Example 2 | −69° C. | 13.7 | 5.1 |
| Example 3 | −66° C. | 13.5 | 5.1 |

TABLE 8

| | | Specification | | |
|---|---|---|---|---|
| | | Limit | Compar- | |
| | | (MIL-PRF- | ative | |
| Property | Test Method | 5606H) | Example 1 | Example 1 |
| Steel on steel | ASTM D 4172 | <1.0 mm | Pass | Pass |
| wear | (Condition B) | | | |
| Low | FED-STD- | No gelling, | Pass | Pass |
| temperature | 791-3458 | crystallisation, | | |
| stability | | solidification | | |
| | | or separation | | |
| Corrosiveness | ASTM D4636 | Test limits | Pass | Pass |
| and oxidation | | specified | | |
| stability | | in spec. | | |

### Elastomer Volume Measurements

In order to determine the seal swelling properties of the fluids of Comparative Example 1 and Examples 1-3, they were subjected to the standard test method FED-STD-791-3603 (70° C., 168 hours, using elastomers meeting the specification SAE AMS 3217/2). Each example was tested in triplicate. Average Results are shown in Table 9 below.

TABLE 9

| | Average | Average | Change in |
|---|---|---|---|
| | Elastomer | Elastomer | Average |
| | Volume before | volume after | Elastomer |
| Example | test/cm³ | test/cm³ | Volume/% |
| Comparative | 2.59 | 3.32 | 27.9 |
| Example 1 | | | |
| Example 1 | 2.54 | 3.07 | 20.7 |
| Example 2 | 2.84 | 3.56 | 25.3 |
| Example 3 | 2.74 | 3.40 | 24.4 |

As can be seen from Table 9 above, the fluid compositions of Examples 1-3 (containing a Fischer-Tropsch derived base oil in addition to a naphthenic base oil) exhibit significantly reduced seal swell compared with the fluid composition of Comparative Example 1 (containing only naphthenic base oil), as evidenced by a lower percentage change in elastomer volume for the fluid compositions of Examples 1 to 3 compared to that of Comparative Example 1.

### Specific Heat Capacity Measurements

The specific heat capacity of the fluid compositions of Comparative Example 1 and of Example 1 was measured according to the standard test ASTM E 1269 at various temperatures. ASTM E 1269 measures the specific heat capacity using differential scanning calorimetry (DSC). The results are shown in Table 10 below.

TABLE 10

| | Comparative | |
|---|---|---|
| Temperature | Example 1 (J/g ° C.) | Example 1 (J/g ° C.) |
| 20° C. | 1.863 | 1.905 |
| 30° C. | 1.889 | 1.939 |
| 40° C. | 1.914 | 1.972 |
| 50° C. | 1.947 | 2.015 |
| 60° C. | 1.981 | 2.055 |
| 70° C. | 2.019 | 2.094 |

As can be seen from Table 10, the fluid composition of Example 1 (containing a Fischer-Tropsch derived base oil in addition to a naphthenic base oil in the base oil composition) has a higher specific heat capacity than the fluid composition of Comparative Example 1 (containing only naphthenic base oil in the base oil composition).

### Evaporation Loss Measurements

The Evaporation Loss of Comparative Example 1 and of Example 1 was measured at 6 hours at 71° C. using the standard test method ASTM 972. The results are shown in Table 11 below.

TABLE 11

| Example | Volume loss (%) |
|---|---|
| Comparative Example 1 | 8.76 |
| Example 1 | 2.26 |

As can be seen from Table 8, the fluid composition of Example 1 (containing a Fischer-Tropsch derived base oil as well as a naphthenic base oil in the base oil composition) exhibited a significantly lower volume loss by evaporation compared to the fluid composition of Comparative Example 1 (containing only naphthenic base oil in the base oil composition).

1. A functional fluid composition comprising:
from 70% to 99.99%, by weight of the functional fluid composition, of a base oil composition comprising:
(i) from 50% to 95%, by weight of the base oil composition, of a naphthenic base oil; and
(ii) from 5% to 50%, by weight of the base oil composition, of a Fischer-Tropsch derived base oil.

2. A functional fluid composition according to claim 1 wherein the naphthenic content of the naphthenic base oil is in the range of from 50% to 90% by weight of the naphthenic base oil.

3. A functional fluid composition according to claim 1 or 2 wherein the functional fluid composition has a pour point of at or below −30° C.

4. A functional fluid composition according to claim 1 wherein the functional fluid composition has a viscosity of at least 3 mm²/s at 100° C.

5. A functional fluid composition according to claim 1 wherein the Fischer-Tropsch derived base oil has a viscosity at 100° C. in the range of from 0.5 to 5 mm²/s.

6. A functional fluid composition according to claim 1 wherein the Fischer-Tropsch derived base oil has a viscosity at 100° C. in the range of from 0.5 to 2 mm²/s.

7. A functional fluid composition according to claim 1 wherein the Fischer-Tropsch derived base oil has a viscosity at 100° C. in the range of from 2 to 4 mm²/s.

8. A functional fluid composition according to claim 1 having a flashpoint of 80° C. or greater.

9. A hydraulic fluid composition comprising the functional fluid composition according to claim 1.

10. A shock absorber fluid composition comprising the functional fluid composition according to claim 1.

11. Use of a functional fluid composition according to claim 1 for reducing the volume swell of synthetic rubbers.
